(19) United States
(12) Patent Application Publication
(10) Pub. No.: US 2009/0188904 A1
(43) Pub. Date: Jul. 30, 2009

(54) Fault Tolerant Heater Circuit

(75) Inventors: Michael S. Schwerer, Plano, TX (US); William C. Strauss, Flower Mound, TX (US)

Correspondence Address: BAKER BOTTS LLP, 2001 ROSS AVENUE, 6TH FLOOR, DALLAS, TX, 75201-2980, US

(73) Assignee: Raytheon Company, Waltham, MA (US)

(21) Appl. No.: 12/022,759

(22) Filed: Jan. 30, 2008

(51) Int. Cl. H05B 11/00

(52) U.S. Cl. 219/209

(57) ABSTRACT

In one embodiment, a heater circuit includes a number of groups which each include a number of resistive elements arranged in an electrically parallel circuit that are coupled between two power terminals in a series circuit. Each resistive element is disposed on the surface of a structure and physically parallel to other resistive elements in the group and to resistive elements in other groups. The width and/or thickness of the resistive elements may be varied to control the heat generated in particular regions.

### GOVERNMENT RIGHTS

This invention was made with Government support under N00024-05-C-5346 awarded by DDG 1000. The Government may have certain rights in this invention.

### TECHNICAL FIELD OF THE DISCLOSURE

This disclosure relates generally to heating devices, and more particularly, to a fault tolerant heater circuit.

### BACKGROUND OF THE DISCLOSURE

Antennas operating in the microwave frequency range use various directing or reflecting elements having relatively precise physical characteristics. To protect these elements, a protective covering commonly referred to as a radome may be placed over the antenna. The radome separates the elements of the antenna from various environmental aspects, such as precipitation, humidity, solar radiation, or other forms of debris that may compromise the performance of the antenna.

### SUMMARY OF THE DISCLOSURE

In one embodiment, a heater circuit includes a number of groups which each include a number of resistive elements arranged in an electrically parallel circuit that are coupled between two power terminals in a series circuit. Each resistive element is disposed on the surface of or embedded within a structure and physically parallel to other resistive elements in the group and to resistive elements in other groups.

Embodiments of the disclosure may provide numerous technical advantages. Some, none, or all embodiments may benefit from the below described advantages. According to one embodiment one advantage may be enhanced fault tolerance provided by the electrically parallel combination of resistive elements in a group. In the event that one resistive element fails due to an open circuit condition, other resistive elements in the group continue to carry current through the heater circuit.

Another advantage that may be provided by certain embodiments may be a series relationship of each of the groups with one another. Use of a series circuit to couple the groups together enables use of two power terminals at either end of the circuit. Thus, interconnection of electrical power to the heater circuit may be simplified by alleviating the need for multiple interconnection points to a heater circuit implemented on a radome.

Other technical advantages will be apparent to one of skill in the art.

### BRIEF DESCRIPTION OF THE DRAWINGS

A more complete understanding of embodiments of the disclosure will be apparent from the detailed description taken in conjunction with the accompanying drawings in which:

FIG. 1 is a perspective view of one embodiment of a heater circuit according to the teachings of the present disclosure that may be implemented on one example of a radome configured on an antenna;

FIG. 2 is a schematic diagram of the heater circuit of FIG. 1;

FIG. 3 is an enlarged, partial view of the radome with an outer layer peeled away to reveal the heater circuit as shown along the lines 3 to 3 of FIG. 1; and

FIG. 4 is an enlarged, cross-sectional view of the radome as shown along the lines 4 to 4 of FIG. 1.

### DETAILED DESCRIPTION OF EXAMPLE EMBODIMENTS OF THE DISCLOSURE

As described previously, antennas may be configured with radomes to protect the antenna from the environment. These radomes are typically electrically insulative to not unduly interfere with the operation of the antenna. Some environmental effects, such as snow or sleet, however, may cause ice to form on the surface of the radome; a condition that may hamper the performance of the antenna's operation.

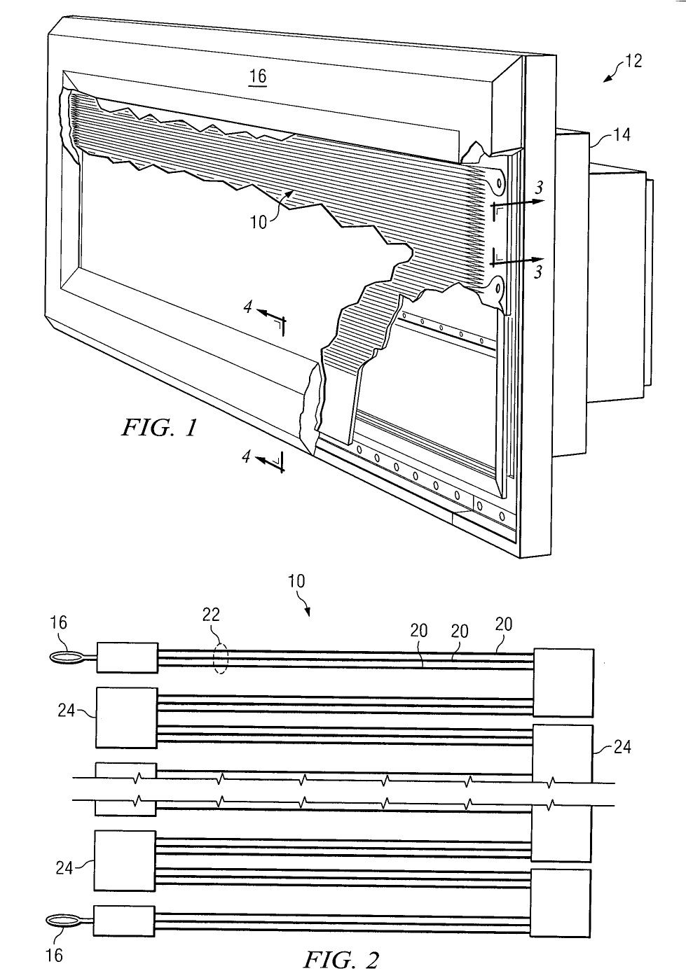

FIG. 1 shows one embodiment of a heater circuit 10 that may be configured on a radome 12 to alleviate the previously described problems as well as other problems. Heater circuit 10 is configured on a radome 12 for protecting various radiating elements (not specifically shown) of an antenna 14. As will be described in detail below, radome 12 generally includes one or more sheets of generally electrically insulative material on which the heater circuit 10 is disposed. Certain embodiments of the heater circuit 10 may be operable to heat the radome 12 for controlling the temperature of the radome's surface.

Although heater circuit 10 is described in the present embodiment as being disposed on a radome 12, it should be appreciated that the heater circuit 10 may be disposed on any suitable structure for which electric heating is desired. Examples of suitable structures may include various portions of aircraft, such as wings, control surfaces, and/or air inlets of engines. Other examples may include radiant heat floor panels, heated ducting, windows, electric blankets, and toasters.

Antenna 14 may be any suitable type of antenna. In the particular example shown, antenna 14 includes elements having an opening that is protected by radome 12; however, other types and shapes of antennas may be used. In one embodiment, an outer ring 16 made of radar absorbing material (RAM) may be configured on the outer periphery of the radome 12 for sealing the edge of the radome 12 to the antenna 10 and/or controlling the radiation pattern of the antenna 14.

FIG. 2 is a schematic diagram of one embodiment of the heater circuit 10 according to the teachings of the present disclosure. Heater circuit 10 generally includes a number of elongated resistive elements 20 that are configured to provide energy as heat when an electrical current is passed through them. Each of these resistive elements 20 may be arranged in an electrically parallel circuit with one another to form a group 22. A number of groups 22 may be configured together in a series circuit with one another by one or more interim nodes 24 and terminated by the two power terminals 16. Certain embodiments incorporating such an electrically parallel/series combination of resistive elements may provide an advantage in that fault tolerance of the overall heater circuit 10 may be enhanced. Fault tolerance may be provided by the electrically parallel combination of resistive elements in which other resistive elements in a particular group continue to operate in the event that one or more particular resistive elements in any particular group fails. For example each of the groups 22 shown in the embodiment of FIG. 2 has three resistive elements 20. Failure of one resistive element 20 in a particular group 22 may still allow electrical current to flow through the other two resistive elements 20. An additional advantage may be provided in that the two remaining resistive elements 20 may provide additional heat to the radome 12 to compensate for heat not provided by the one failed resistive element 20.

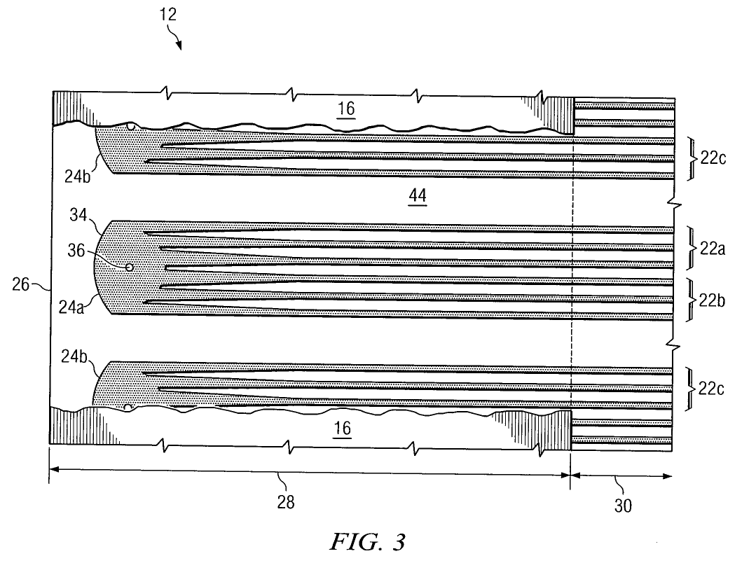

FIG. 3 shows an enlarged view of a portion of the heater circuit 10 of FIG. 1. As shown, a first group 22a of resistive elements 20 are connected to a second group 22b of resistive elements 20 by a generally pie-shaped interim node 24a. Each of the resistive elements 20 may be connected to other interim nodes (not specifically shown) disposed on the other side of the radome 12 such that they extend over the surface of radome 12. Successive groups 22c of resistive elements 20 may be interconnected in a series circuit by other interim nodes 24b for generally even coverage of resistive elements 22 over the surface of the radome 12.

In one embodiment, the resistive elements 20 and interim nodes 24 may be integrally formed together by etching a copper plated insulative membrane 44 that may be used to form a layer of the radome 12. It should be understood, however, that resistive elements 20 and interim nodes 24 may be created using any suitable approach. For example, each of the resistive elements 20 may be formed of partially conductive material, such as nichrome wire, that is coupled to and extending between successive interim nodes 24 and/or power terminals 16. As another example, the resistive elements 20 and interim nodes 24 may be integrally formed of Inconel™ foil using a chemical milling process.

In the embodiment shown, each resistive element 20 is generally straight in shape and physically parallel to other resistive elements 20 in its respective group. As also shown, each resistive element 20 may be physically parallel with resistive elements 20 of other groups 22 such that the resistive elements 20 extend across the surface of the radome 12 in the same general direction. In this manner, the radome 12 may be oriented on the antenna 10 such that the resistive elements 20 extend over the radome 12 in a direction that may be generally orthogonal to a direction of polarization of the antenna 10. In other embodiments, each resistive element 20 may have a generally serpentine, wave-like, or tortuous shape. The serpentine shape of the resistive elements 20 may provide resiliency in order to prevent failure due to flexure or bowing of the radome 12 during use. Resistive elements 20 having a serpentine shape may be essentially straight to not unduly interfere with the propagation characteristics of the antenna 10, yet having a relatively slight periodic deviation lateral to its elongated extent.

Interim nodes 24 may be disposed proximate the outer periphery 26 of the radome 12 and provide interconnection to adjacent groups 22 of resistive elements 20 that extend across the radome 12 to other interim nodes (not specifically shown). Edge region 28 indicates an area of the radome 12 that may be disposed adjacent outer ring 16 when configured on antenna 10. Field region 30 indicates the central portion of the radome 12 not covered by the outer ring 16. Because outer ring 16 may be thermally insulative, it may be beneficial to reduce heating of the edge region 28 relative to the field region 30 during use. Thus in one embodiment, the width of individual resistive elements 20 may be relatively wider in the edge region 28 than in the field region 30. Because effective resistance is inversely proportional to the cross-sectional area of each resistive element 20, portions of each resistive element 20 having increased thickness and/or width will provide an inversely less amount of heat during operation.

In another embodiment, the width of the resistive elements 20 in the edge region 28 may be tapered from the interim nodes 24 to the field region 30. For the particular embodiment shown, resistive elements 20 may have a width of 0.035 inches proximate the interim nodes 24 and tapering to a width of 0.011 inches in the field region 30. Certain embodiments incorporating tapered resistive elements 20 may provide an advantage in that gradual widening from one width to another may avoid discontinuities that may in turn create undesirable electromagnetic reflections.

In another embodiment, interim nodes 24 and resistive elements 20 in the edge region 28 may be coated with a conductive plating to increase the thickness, thereby, further reducing resistance and thus heating in this region. Conductive plating may be formed from any conductive material that may be adhered to interim nodes 24 and resistive elements 20 and may be, for example, copper or other similar type material.

Interim nodes 24 may have any configuration that couples individual resistive elements 20 of a particular group 22 in an electrically parallel circuit and couples adjacent groups of resistive elements 20 together in a series circuit. Each interim node 24 has an electrical resistance that may be less than the electrically parallel combination resistance of each group 22 of resistive elements 20. In one embodiment, interim nodes 24 couple adjacent groups 22 together such that these groups 22 extend in essentially the same direction. In this manner, the resistive elements 20 of the groups 22 may be essentially physically parallel to allow orthogonal placement with respect to the antenna's 10 direction of polarization.

In one embodiment, each resistive element 20 in a group 22 may be coupled to the interim node 24 at a point that may be relatively closer to the rear edge 34 of the interim node 24 as its lateral distance from a centroid 36 of the interim node 24 increases. The centroid 36 generally refers to a geometrically weighted central portion of the interim node 24. By disposing connection points of each resistive element 20 in such a manner, electrical current may be distributed in a relatively more even manner through the interim node 24 during operation, thereby generating a power density equivalent to group 22.

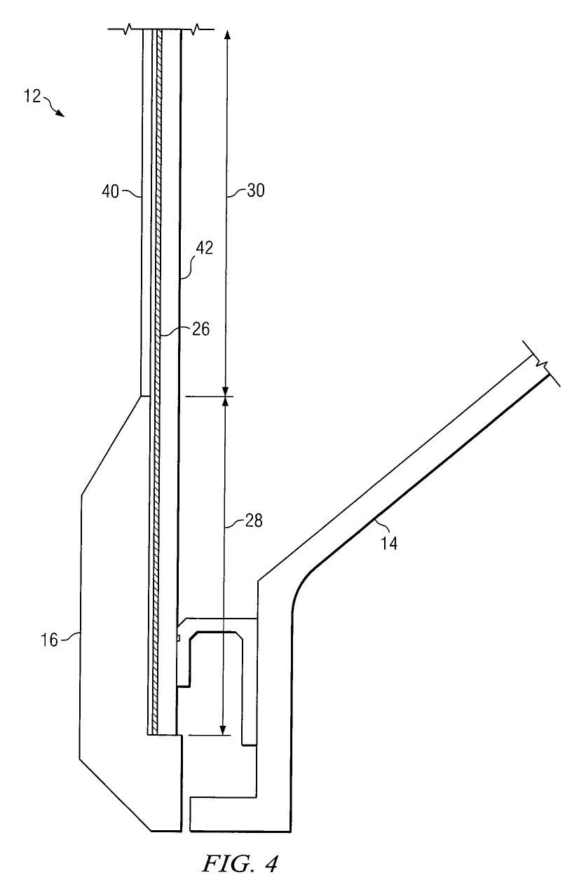

FIG. 4 is an enlarged partial, side cross-sectional view showing the arrangement of the heater circuit 10 as seen along the lines 3 to 3 of FIG. 1. As shown, heater circuit 10 may be embedded on a layered surface of the radome 12. It should be appreciated, however, that the heater circuit 10 may be disposed on any suitable surface, such as an outer surface 40 or inner surface 42 of the radome 12. In one embodiment, resistive elements 20 and interim nodes 24 may be formed by etching a copper plated insulative membrane 44, such as flame resistant 4 (FR4) or other similar type material. During assembly, the heater circuit 10 and electrically insulative membrane 44 may be on or in between other layers to form the radome 12. Other layers may include any generally electrically and/or thermally insulative material such as flame resistant 4 (FR4), e-glass, foam, or other suitable materials. In one embodiment, layers adjacent the heater circuit 10 may be formed of a polyimide film, such as Kapton™.

A heater circuit 10 has been described that may provide a relatively reliable approach to heating a radome 12. Enhanced reliability is provided by electrically parallel combinations of resistive elements 20 in which a failure of one particular resistive element 20 does not cause the heater circuit 10 to cease functioning. Interim nodes 24 are also described that distribute current through each of the resistive elements 20 in a relatively even manner. According to one embodiment, the resistive elements 20 and interim nodes 24 may be integrally formed from a piece of copper clad insulative membrane that is relatively easy to form and integrate with other components of the radome 12. For regions where the heat generated is to be minimized such as underneath of absorber 16, the resistive elements 20 can be widened and/or plated thicker and interim nodes 24 can be made larger or plated thicker.

Although several embodiments have been illustrated and described in detail, it will be recognized that substitutions and alterations are possible without departing from the spirit and scope of the present disclosure, as defined by the following claims.

What is claimed is:

1. A heater circuit comprising:
first and second power terminals for coupling of electrical power to the heater circuit;
an interim node formed from a copper trace;
a plurality of first resistive elements disposed on an inner surface of a radome and configured in an electrically parallel circuit between the first power terminal and the interim node, each of the first resistive elements formed of an elongated copper trace that is essentially straight and physically parallel to the other plurality of first resistive elements; and
a plurality of second resistive elements disposed on the inner surface and configured in an electrically parallel circuit between the second power terminal and the interim node, each of the second resistive elements formed of the elongated copper trace that is essentially straight and physically parallel to the other plurality of second resistive elements;
wherein each first resistive element and second resistive element is coupled to the interim node at a first connection point that is relatively closer to a rear portion of the interim node as its lateral distance from a centroid of the interim node increases.

2. A heater circuit comprising:
first and second power terminals for coupling of electrical power to the heater circuit;
an interim node;
a plurality of first resistive elements disposed on a surface of a structure and configured in an electrically parallel circuit between the first power terminal and the interim node, each of the first resistive elements formed of an elongated material that is essentially physically parallel to the other plurality of first resistive elements; and
a plurality of second resistive elements disposed on the surface and configured in an electrically parallel circuit between the second power terminal and the interim node, each of the second resistive elements formed of the elongated material that is essentially straight and essentially physically parallel to the other plurality of second resistive elements and to the plurality of first resistive elements.

3. The heater circuit of claim 2, wherein each first resistive element and second resistive element is coupled to the interim node at a first connection point that is relatively closer to a rear portion of the interim node as its lateral distance from a centroid of the interim node increases.

4. The heater circuit of claim 2, wherein each of the plurality of first resistive elements and the plurality of second resistive elements having a serpentine shape such that its lateral deviation is substantially less than its longitudinal extent.

5. The heater circuit of claim 2, wherein the elongated material is a copper trace.

6. The heater circuit of claim 5, wherein the interim node is a copper trace that is integrally formed with each of the first and second plurality of resistive elements.

7. The heater circuit of claim 2, wherein the elongated material is an at least partially conductive metal.

8. The heater circuit of claim 2, wherein the elongated material is made of a material selected from the group consisting of nichrome, copper, and metal alloy.

9. The heater circuit of claim 2, wherein the first plurality of resistive elements extend away from the interim node in a direction that is different from a direction which the second plurality of resistive elements extend.

10. The heater circuit of claim 9, wherein the first plurality of resistive elements extend away from the interim node in a first direction that essentially similar to a second direction from which the second plurality of resistive elements extend.

11. The heater circuit of claim 2, wherein the surface is an inner surface of the structure.

12. The heater circuit of claim 2, wherein the heater circuit is embedded within the structure.

13. The heater circuit of claim 2, wherein the interim node has an electrical resistance that is substantially less than the resistance of the electrically parallel combination resistance of the plurality of first resistive elements or the plurality of second resistive elements.

14. The heater circuit of claim 2, wherein the structure is selected from the group consisting of a radome, a blanket, a window, a wing, a helicopter, a section of flooring, a heating element for a water heater, and an oven.

15. The heater circuit of claim 2, wherein the interim node comprises a plurality of interim nodes.

16. The heater circuit of claim 2, wherein the first and second power terminals, the interim node, the plurality of first resistive elements, and the plurality of second resistive elements are monolithically formed from a layer of copper using a copper etching process.

17. An apparatus comprising:
a radome having an outer periphery and a surface, the radome having an outer ring disposed adjacent the outer periphery, the surface having an edge region that is covered by the outer ring and a field region that is not covered by the outer ring; and
a heater circuit disposed on the surface, the heater circuit comprising:
first and second power terminals for coupling of electrical power to the heater circuit;
an interim node;
a plurality of first resistive elements configured in an electrically parallel circuit between the first power terminal and the interim node, each of the first resistive elements formed of an elongated material that is essentially physically parallel to the other plurality of first resistive elements; and
a plurality of second resistive elements configured in an electrically parallel circuit between the second power terminal and the interim node, each of the second resistive elements formed of the elongated material that is essentially physically parallel to the other plurality of second resistive elements and to the plurality of first resistive elements;
wherein each of the plurality of first resistive elements and the plurality of second resistive elements has a width that is wider in the edge region than in the field region.

18. The apparatus of claim 17, wherein the thickness of each of the plurality of first resistive elements and the plurality of second resistive elements is tapered from the interim node to the field region.

19. The apparatus of claim 17, wherein each of the plurality of first resistive elements and the plurality of second resistive elements in the edge region is plated with a conductive material.

20. The apparatus of claim 19, wherein the conductive material is copper.

21. The apparatus of claim 17, wherein the first and second power terminals, the interim node, the plurality of first resistive elements, and the plurality of second resistive elements are monolithically formed from a layer of copper using a copper etching process.
